(19) United States
(12) Patent Application Publication
(10) Pub. No.: US 2016/0114569 A1
(43) Pub. Date: Apr. 28, 2016

(54) METHOD OF MANUFACTURING ANTI-SLIPPING PAD

(71) Applicant: Su-Tuan Hsu Tang, Tao-Yuan Hsien (TW)

(72) Inventor: Su-Tuan Hsu Tang, Tao-Yuan Hsien (TW)

(21) Appl. No.: 14/525,922

(22) Filed: Oct. 28, 2014

(51) Int. Cl. B32B 38/08; B32B 27/12; B32B 37/18; B29C 65/00; B32B 38/18; B32B 37/00; B32B 37/08; B32B 5/02; B32B 38/00

(52) U.S. Cl. CPC B32B 38/08; B32B 5/024; B32B 27/12; B32B 37/18; B32B 38/0036; B32B 38/18; B32B 37/0053; B32B 37/08; B29C 66/45; B29C 66/72; B32B 2266/0214; B32B 2262/062; B32B 2262/08; B32B 2307/744; B32B 2307/402; B32B 2419/00; B32B 2327/06; B32B 2331/00; B32B 2319/00; B32B 2383/00; B32B 2333/00; B29K 2009/06

(57) ABSTRACT

In a method of manufacturing an anti-slipping pad, a braid mainly serves as a central main structure. A shaped underlying layer serving as a base, and a soft paste-like foaming paste of a surface layer, which is not shaped, are fused by high temperature into an integrally covered sandwich structure. The method comprises the steps of: leveling baking, laminating transporting, showering foaming, foaming shaping and cooling completing so that the braid is clamped between the foaming shaped foaming paste and the underlying layer to strengthen the overall anti-slipping pad structure and to help the process advancing and property enhancing of the products, such as cabinet pads, place mats and the like.

### BACKGROUND OF THE INVENTION

(1) Field of the Invention

The invention relates to a method of manufacturing an anti-slipping pad, and more particularly to a method of manufacturing an integrally formed anti-slipping pad by way of one-time foaming shaping and glue-free technology.

(2) Description of the Prior Art

The frequently seen and widely used anti-slipping pads, such as drawer pads, table pads, cabinet pads and other pad applications, have the removable, anti-slip and non-adhesive functions, and can be used to cover articles.

There are a lot of products similar to the above-mentioned structures. For example, U.S. Pat. No. 5,863,845 provides a surface anti-slip product without the self adhesive. This product comprises a surface structure, a bottom surface structure and a top surface layer adhered to the surface structure. The overall product has the anti-slip function at least on the underlying layer structure but is not the self adhesive. The covering product comprises a surface layer adhered to the surface of the substrate. The slip-resistant substrate provides the slip-resistant property to the covering product with respect to the corresponding surface structure regardless of the parallel direction or lateral direction.

Next, U.S. Pat. No. 5,874,371 provides a plastic material braid having a top surface, a bottom surface and holes; wherein the fabric is coated with the cured slip-resistant PVC resin; and a coated and adhesive top sheet, also referred to as a top surface of a shielding member. The top surface is coated with the ink adapted to contact with the food. An anti-slip PVC resin is coated on the base layer, and at least on the bottom of the bottom surface layer.

Also, U.S. Pat. No. 6,130,174 provides an adhered product comprising a continuous ordinary flat PVC surface layer and a grid layer comprising the coated PVC foaming material, wherein the grid layer is combined with the flat surface material layer by an adhesive (glue).

Furthermore, U.S. Pat. No. 6,221,796 B1 provides an anti-slip cabinet pad product having a continuous flat vinyl plastic sheet, wherein a foaming polyvinyl chloride (PVC) plastic material sheet layer is coated on the fabric base or this is combined to the surface layer of the fabric base by an adhesive agent.

In addition, FIG. 1 shows a conventional anti-slipping pad structure, wherein the anti-slipping pad (A) can cover and can be removed and has anti-slip and non-adhesive characteristics. The technological construction comprises two manufacturing processes. The first process is to cover a well shaped fabric base (scrim) or fabric with a foaming material, to produce an anti-slip net (B) through the foaming process, and then the anti-slip net (B) is to be stacked above a substrate (D) formed by polyvinyl chloride (PVC). The second process is to use the heating adhering process with the adhesive (C) serving as a medium to permanently adhere both of them together.

According to the descriptions of the U.S. Patents and the conventional anti-slipping pad, it is not difficult to find that the anti-slip and non-self-adhesive products have been widely used by the public. However, most of all these structures of the anti-slipping pad products are to improve the conventional pad product having the adhesive backside. Thus, the conventional pad product being used cannot be easily removed or may be damaged due to the too-large adhesive force.

In the manufacturing of the pad product, an adhesive or a glue mainly serves as the combination medium between two substrates. The pad manufactured in such a way has the following drawbacks in the manufacturing processes. First, when the foaming shaped anti-slip net is adhered to the underlying layer, baking and drying need to be performed. However, the previously foaming shaped anti-slip net has been heated and thermally cured, so the anti-slipping pad must be heated again to perform the adhering process, so that the anti-slip net surface is coked, thereby decreasing or losing the anti-slip ability. In addition, the exterior tends to be flattened and lose the beauty. Second, when the adhesive adhering method is used to achieve the combination process, the resiliences against various environmental conditions are also different because the adhesive and the to-be-adhered material have different properties, thereby causing the adhesive portion to deteriorate after the anti-slipping pad is used at the high-temperature environment or for a long period of time. In this case, the adhered portion is peeled off to encounter the separating risk. More particularly, after a long-term use and the dirtiness adhered to the surface is to be removed by way of rubbing or by a washer or dryer, the ungluing and peeling off tend to occur, thereby shortening the lifetime and causing inconvenience in washing. Third, the process of adhering the foaming anti-slip net to the underlying layer needs the second heating process, thereby further deteriorating the functionality of the anti-slip net, and different degrees of absorptive and adhesive forces cannot be produced. Alternatively, the anti-slipping pad without the diversified performances in the absorptive and adhesive forces has one single function, the consumer has the few choices, and the diversified requirements of the modern users cannot be satisfied.

In view of this, the present inventor has paid attention to the research and development according to the experience and the technology in manufacturing the associated products for many years, and thus developed this method of manufacturing an anti-slipping pad to effectively solve the problem and further to achieve the environment protection and carbon reduction and enhance the effectiveness of industry upgrade.

### SUMMARY OF THE INVENTION

A main object of the invention is to provide a method of manufacturing an anti-slipping pad to advance the product manufacturing processes, to decrease the energy consumption, to satisfy the environment protection and carbon reduction of the current industry, and to completely eliminate the drawback of the separation risk of the product formed by way of adhering. Thus, an anti-slipping pad having a sandwich strengthened structure, which is integrally foaming shaped and clamps the braid in the middle, can be formed.

Another object of the invention is to provide a method of manufacturing an anti-slipping pad so that the facture has the strengthened structure. Meanwhile, the advance and concentrated one-time process can easily manufacture anti-slipping pads with different degrees of anti-slip effects or adhesive forces, thereby creating the multi-purpose household pads, such as anti-slipping pads, cabinet pads or the like.

To achieve the above-identified objects, the invention provides a method of manufacturing an anti-slipping pad, the method comprising: (A) a leveling baking step of spreading and then baking a braid; (B) a laminating transporting step of laminating the braid with an underlying layer and integrally transporting the braid and the underlying layer to a material showering platform; (C) a showering foaming step of showering a foaming paste over a surface of the laminated braid and underlying layer to perform foaming; (D) a baking shaping step of baking the underlying layer to be softened and combined with the foaming paste to cover the braid to form a sandwich structure; and (E) a cooling completing step of cooling the sandwich structure to change from the fused state to a compacted solid semi-facture.

The braid is selected from one of the group consisting of artificial silk, hemp, cotton and wovens.

The foaming paste and the underlying layer are made of the same material, which is selected from one of the group consisting of polyvinyl chloride (PVC), polymer environment resin (PER), vinyl ester resin (EVA), nitrile butadiene rubber (NBR), styrene butadiene rubber (SBR), silicone and acrylic.

The underlying layer has a waterproof effect, and has a surface, on which textures, colors or patterns can be printed.

The underlying layer may also have the water-absorbing effect, and the surface is made of one of the group consisting of artificial fiber, polyester, nylon, cotton, hemp and wovens.

A system of manufacturing an anti-slipping pad to perform this method comprises: an expanding roller for spreading and leveling a braid; a high-temperature oven for removing moisture from the braid, and shaping the braid; a transportation device for pressing the braid against an underlying layer and transporting the braid and the underlying layer integrally; a material showering platform, above which a funnel is disposed, the material showering platform showering a foaming paste over the braid and the underlying layer laminated together; a foaming furnace providing a heating function to fuse the foaming paste and the underlying layer together to form a sandwich structure; and a cooling device providing a cooling function to cool the sandwich structure into a compacted solid.

The funnel has an opening for controlling surface patterns showered over the braid and the underlying layer, wherein the surface patterns comprise: regular strip-like patterns, dotted patterns, texture-like patterns or single-film patterns.

The foaming furnace has upper and lower heating devices, and a temperature of the foaming furnace can reach 200° C.

The system further comprises a retractor for retracting a semi-facture formed after cooling.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 shows a conventional anti-slipping pad structure.

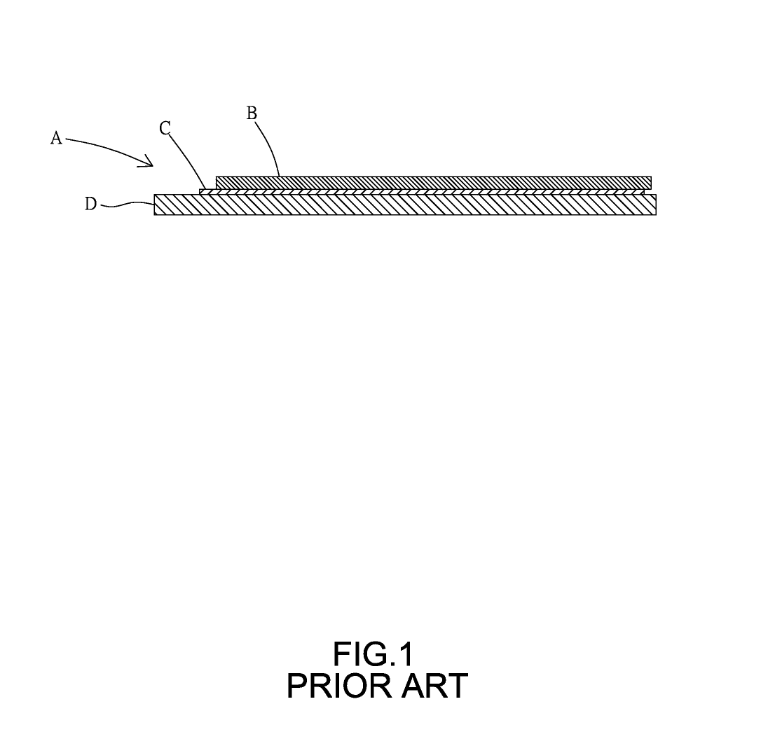

FIG. 2 is a flow chart showing a method of the invention.

FIG. 3 is a schematic view showing a system arrangement in the method of the invention.

FIG. 4 is a schematic view showing an anti-slipping pad material laminating in the method of the invention.

FIG. 5 is a schematic view showing an anti-slipping pad structure manufactured by the method of the invention.

FIG. 6 is a schematic view showing another pattern of the anti-slipping pad manufactured by the method of the invention.

### DETAILED DESCRIPTION OF THE PREFERRED EMBODIMENTS

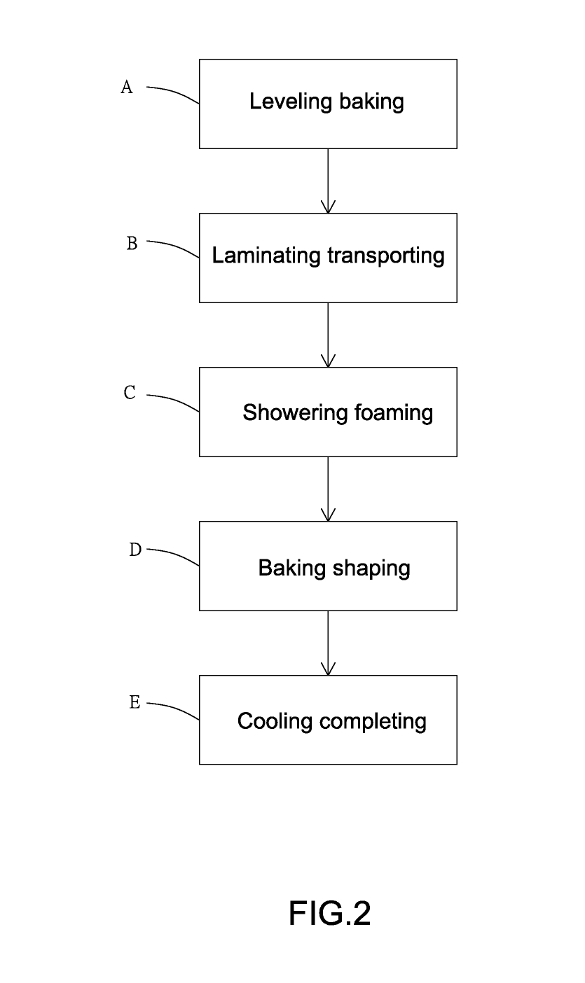

Referring to FIG. 2, a method of manufacturing an anti-slipping pad according to the invention comprises the steps of: (A) leveling baking; (B) laminating transporting; (C) showering foaming; (D) baking shaping; and (E) cooling completing.

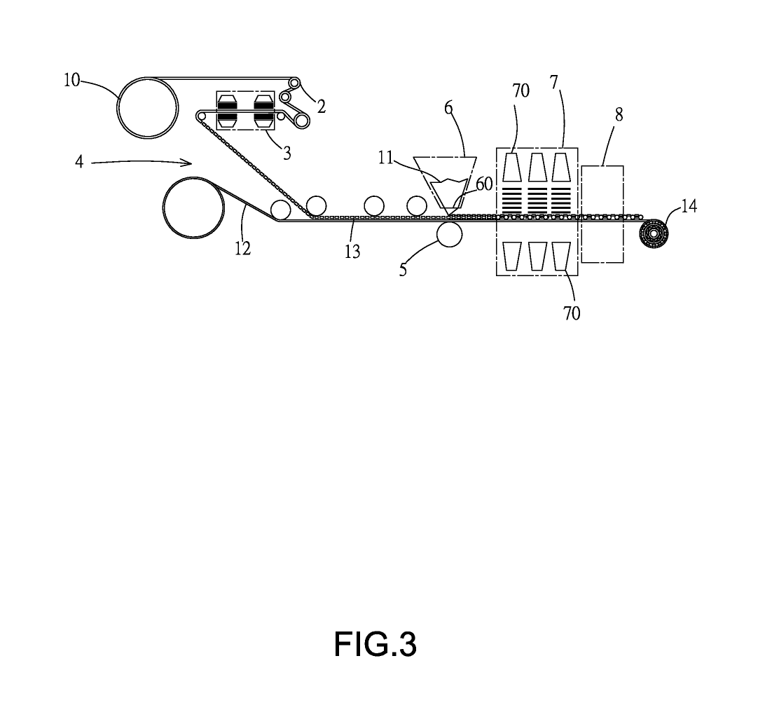

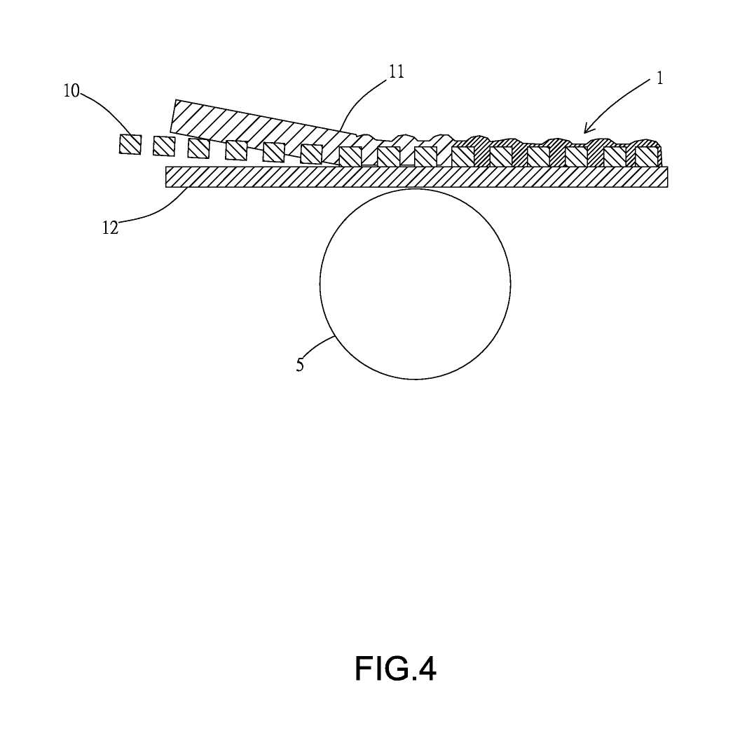

Referring to FIGS. 2 to 4, the required system arrangement according to the above-mentioned method comprises: an expanding roller 2 for spreading and leveling a braid 10; a high-temperature oven 3 for removing moisture from the braid 10 and shaping the braid 10 so that the braid 10 cannot be easily retracted; a transportation device 4 for pressing the braid 10 against an underlying layer 12 to form a laminated structure 13, and then transporting the laminated structure 13; a material showering platform 5, above which a funnel 6 is disposed, wherein the material showering platform 5 showers a foaming paste 11 over the laminated structure 13 formed by the braid 10 and the underlying layer 12; a foaming furnace 7 for providing a heating function to fuse the foaming paste 11 and the underlying layer 12 into a sandwich structure; and a cooling device 8 for providing a cooling function to cool the sandwich structure into a compacted solid.

In the leveling baking step (A) of this method, the braid 10 is spread and leveled through the expanding roller 2, and then enters the high-temperature oven 3, in which the moisture is removed and the braid 10 is shaped.

In the laminating transporting step (B) of this method, the transportation device 4 transports the leveled braid 10 and the underlying layer 12 and presses the braid 10 against the underlying layer 12 to form an adhered laminated structure 13, and transports the adhered laminated structure 13 to the material showering platform 5.

In the showering foaming step (C) of this method, the foaming paste 11 is showered over the laminated structure 13 moving past the material showering platform 5, wherein the funnel 6 is disposed above the material showering platform 5, and the prepared foaming paste 11 is showered over the surface of the laminated structure 13 and flows to the top of the underlying layer 12 through the gaps of the braid 10 according to the liquidity of the foaming paste 11.

The funnel 6 has an opening 60. The opening 60 can be used in conjunction with the control method to shower the foaming paste 11 over the laminated structure 13 in different manners to form patterns comprising regular lines, such as strip-like lines or dotted lines.

In addition, as the prepared amount of the foaming paste 11 gets fewer, the density gets lower, and the relative anti-slip ability gets lower. As the prepared amount of the foaming paste 11 gets more, the density gets higher, and the relative anti-slip ability gets higher.

In the baking shaping step (D) of this method, the laminated structure 13 showered with the foaming paste 11 is transported into the foaming furnace 7 through the transportation device 4. The foaming furnace 7 has upper and lower heating devices 70, and has the temperature which can reach 200° C. In order to prevent the shaped underlying layer 12 from being melted and damaged by the high temperature when the upper and lower heating devices heat concurrently, only the upper heating device 70 is used to bake the foaming paste 11. After a suitable period of time is elapsed and the temperature control is performed, the foaming paste 11 can be softened and combined with the softened contact surface of the underlying layer 12. Because the foaming paste 11 and the underlying layer 12 are made of the same material, they can be fused together while clamping the braid 10 thereinbetween to form a sandwich structure.

In the cooling completing step (E) of this method, the transportation device 4 further transports the combined sandwich structure to the cooling device 8 to perform the cooling to change from the fused state to a compacted solid state.

The cooled semi-facture 14 formed after the final cooling completing step (E) can be retracted by a retractor. In practice, the required suitable size can be cut according to the usage and the requirements for different applications, such as bedding, place mat, scarf and the like.

Comparing the manufacturing method of the invention with the conventional method, the conventional method produces the anti-slip net by way of foaming process, and then utilizes the heating adhering process to adhere the printed sheet to the anti-slip net, while the invention directly finishes the facture with the same functionality using one foaming process. So, the prior art uses two processes, while the invention uses only one process. So, the manufacturing method of the invention improves the drawback of the prior art in the aspect of energy saving and carbon reduction.

In the manufacturing method of the invention, the function of the foaming paste 11 is to form the surface material of the braid 10 to be fused together with the underlying layer 12 to get rid of the use of the combining medium of the adhesive. The prepared density of the foaming paste 11 relates to the used amount, so that different anti-slipping pads with different anti-slip abilities can be produced. If the low anti-slip requirement is needed, the foaming paste 11 can be adjusted to the low density and the low usage amount. On the contrary, if the anti-slip requirement is high, the foaming paste 11 can be adjusted to have the high density and the high usage amount, so that the diversified requirements of the users can be satisfied.

The manufacturing method of the invention produces the anti-slipping pads according to different uses or requirements by controlling the density and the usage amount of the foaming paste 11, so that the anti-slipping pads 1 comprising the suitable adhesive property, the middle adhesive and absorptive property, the completely non-adhesive property and the like can be produced. The surface of the anti-slipping pad 1 may have different degrees of absorptive and adhesive forces or have no absorptive and adhesive force, and the anti-slipping pad 1 can be easily removed without leaving trace, wherein the suitable adhesive property represents the placement on the ordinary plane, such as the usage of the table pad or cabinet pad; the middle adhesive property represents the adhesive placement on the inclined surface or even the reversely inclined surface, such as the placement on the window, toilet bowl pad and windshield; and the completely non-adhesive property replacement represents the use requirement of the non-adhesive or anti-slip requirement, such as the placement of the place mat, game pad or the like.

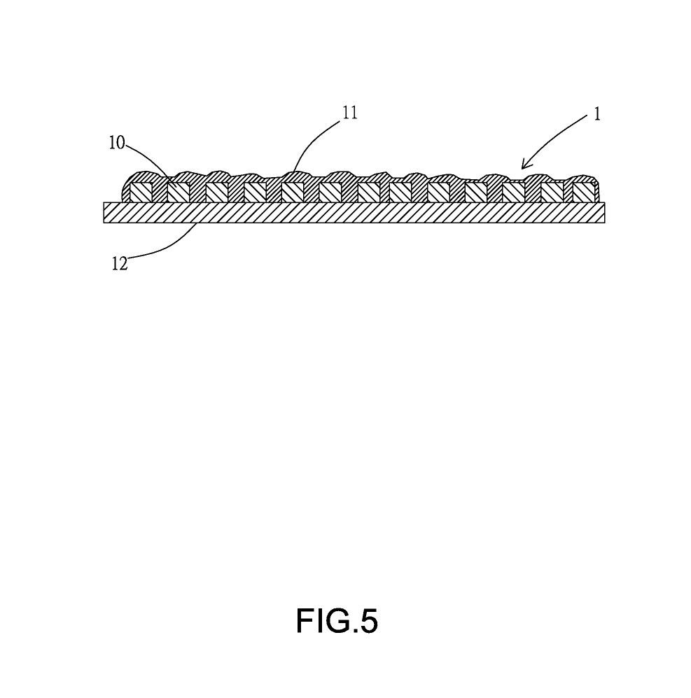

FIG. 5 shows the anti-slipping pad structure manufactured by the method of manufacturing the anti-slipping pad, wherein the braid 10 is disposed above the underlying layer 12, and the foaming paste 11, which is not shaped, is poured over the braid 10 and then the baking is performed. Thus, the foaming paste 11 is heated and then flows to the surface of the underlying layer 12 through the braid 10, and then combined together to form the sandwich structure through the high-temperature foaming action. The foaming paste 11 on the surface of the sandwich structure has the anti-slip function, and the underlying layer 12 on the bottom surface may have the waterproof function or water-absorbing function.

The anti-slipping pad 1 manufactured by the invention has the strengthened structure and is different from the typical anti-slipping pad in that the invention adopts the integral forming technology of one-time high-temperature heating to make the shaped underlying layer 12 and the unshaped surface foaming paste 11 be combined together through the high-temperature foaming, so that the firm single organization is formed without the prior art adhering process using the adhesive. So, no peel off is caused due to the high-temperature environment or the long-time usage. Also, the anti-slipping pad 1 is a soft pad and has the structure formed by combining with the underlying layer having the same material by way of foaming to become a single compatible organization. For the dirtiness adhered to the surface or the daily necessary cleaning habit, the soft pad can be rubbed or washed by the washer or dryer without the ungluing and peeling-off phenomena. So, the cleaning can be performed extremely conveniently, and the lifetime can be lengthened.

The braid, foaming paste and underlying layer in the manufacturing method of the invention may be implemented by various materials. The braid 10 may be made of the artificial silk, hemp, cotton or other wovens with the same kind, and serves as the main central structure of the product. The foaming paste 11 and the waterproof underlying layer 12 must be made of the homogeneous material to facilitate the combined product in having the stable material and the high malleability. So, the materials of the foaming paste and the underlying layer may be polyvinyl chloride (PVC), polymer environment resin (PER), vinyl ester resin (EVA), nitrile butadiene rubber (NBR), styrene butadiene rubber (SBR), silicone or acrylic.

The invention can be applied to the selection of the foaming paste material according to the property of each material. Thus, it is possible to manufacture the sandwich structure with the anti-slip property, without the anti-slip property, with the adhesive (absorptive) property or the incapability of easy removal (high absorptive) property, and the surface has different degrees of absorptive and adhesive forces or has no absorptive and adhesive force, and can be easily removed without leaving any trace. The suitable adhesive property represents the placement on the ordinary plane, such as the usage of the table pad or cabinet pad; the middle adhesive property represents the adhesive placement on the inclined surface or even the reversely inclined surface, such as the placement on the window, toilet bowl pad and windshield; and the completely non-adhesive property replacement represents the use requirement of the non-adhesive or anti-slip requirement, such as the placement of the place mat, game pad or the like. This is the maximum added value of the new bedding product manufactured by the invention.

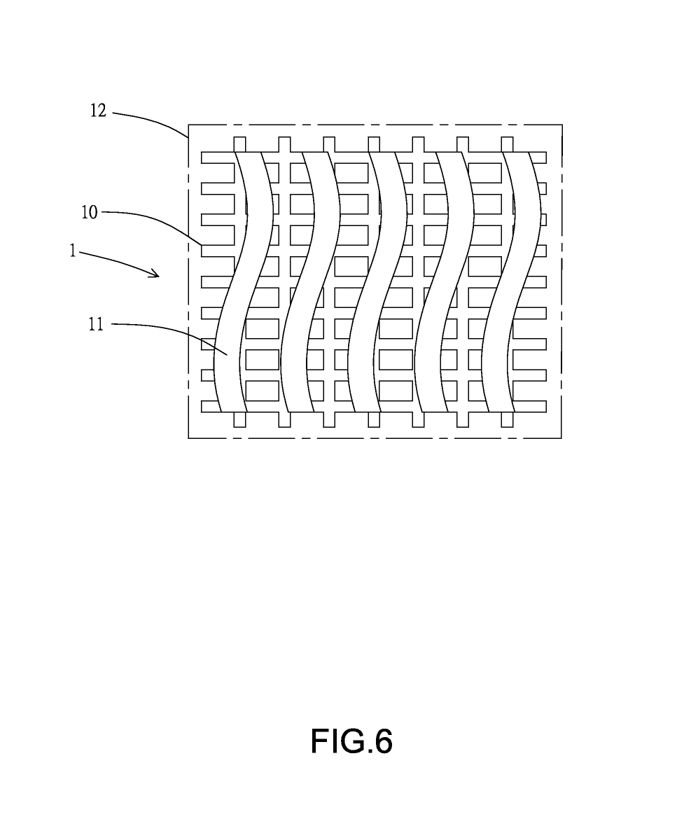

Referring to FIG. 6, in addition to the applications of different materials to manufacture the anti-slipping pads 1 with multiple anti-slip effects, the invention can manufacture more lively and diversified surface textures or color layers having more visual effects. The underlying layer 12 has the waterproof effect due to the material property, and has the surface on which various textures, colors, patterns and the like can be selectively printed. In addition, the rotating material roller is disposed on the material showering platform 5 and works in conjunction with the control action of the opening 60 of the funnel 6 to perform various showering operations, so that the foaming paste 11 is showered over the surface pattern of the braid 10 of the laminated structure 13 to form patterns comprising regular strip-like patterns, dotted patterns, texture-like patterns or single-film patterns.

Also, the underlying layer 12 may further comprise a weaving procedure so that the underlying layer 12 has the water-absorbing effect, and has the surface, on which textures, colors, patterns or the like can be printed. This product can be applied to the countertop and the bathroom washbasin countertop, and have the water-absorbing and wiping functions.

In addition, each layer of material structure in the shaped sandwich structure may be colored in the manufacturing processes for the sake of distinguishing, so that the constructed sandwich anti-slipping pad has different color layers at the same time, and the overall product is rich in the visual aesthetic feelings and creativity.

In summary, the invention particularly utilizes the same material in conjunction with a shaped underlying layer, and a surface layer, which is not shaped, to cover and clamp a braid to constitute a creatively integrally formed sandwich structure. Meanwhile, more integrally formed anti-slipping pads with different usages can be made according to the requirement of the anti-slip effect. Compared this invention with the prior art, in which the semi-facture is formed and then the gluing process is performed, the invention only needs one foaming process to direct finish the adhering process without the gluing and the two manufacturing processes. This method can form the anti-slip surface having the strengthened structure, and the attached dirtiness can be vigorously washed without the peel-off phenomenon. The facture thereof can be cut into the suitable size applied to the bedding, place mat or scarf. The method of the invention improves the technology that cannot be achieved by the prior art, and can shorten the working time, decrease the energy consumption and achieve the environment protection and carbon reduction objects.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A method of manufacturing an anti-slipping pad, the method comprising:
(A) a leveling baking step of spreading and then baking a braid;
(B) a laminating transporting step of laminating the braid with an underlying layer and integrally transporting the braid and the underlying layer to a material showering platform;
(C) a showering foaming step of showering a foaming paste over a surface of the braid and the underlying layer laminated together to perform foaming;
(D) a baking shaping step of baking the underlying layer to be softened and combined with the foaming paste to cover the braid to form a sandwich structure; and
(E) a cooling completing step of cooling the sandwich structure to change from a fused state to a compacted solid semi-facture.

2. The method according to claim 1, wherein the braid is selected from one of the group consisting of artificial silk, hemp, cotton and wovens.

3. The method according to claim 1, wherein the foaming paste and the underlying layer are made of the same material, which is selected from one of the group consisting of polyvinyl chloride (PVC), polymer environment resin (PER), vinyl ester resin (EVA), nitrile butadiene rubber (NBR), styrene butadiene rubber (SBR), silicone and acrylic.

4. The method according to claim 1, wherein the underlying layer has a waterproof effect, and has a surface, on which textures, colors or patterns can be printed.

5. The method according to claim 1, wherein the underlying layer may be processed by a weaving procedure in advance to have a water-absorbing effect, and to have a surface, on which textures, colors or patterns can be printed, wherein the anti-slipping pad is applicable to a countertop and a bathroom washbasin countertop and has water-absorbing and wiping functions.

6. The method according to claim 1, wherein when the braid, the foaming paste and the underlying layer are shaped, different colors can be selected or added so that a three-layer structure product has three colors stacked, and the stacked colors represent a stereoscopic effect, which is not equivalent to a multi-color printing effect of the underlying layer.

7. A system of manufacturing an anti-slipping pad, the system comprising:
an expanding roller for spreading and leveling a braid;
a high-temperature oven for removing moisture from the braid, and shaping the braid;
a transportation device for pressing the braid against an underlying layer and transporting the braid and the underlying layer integrally;
a material showering platform, above which a funnel is disposed, the material showering platform showering a foaming paste over the braid and the underlying layer laminated together;
a foaming furnace providing a heating function to fuse the foaming paste and the underlying layer together to form a sandwich structure; and
a cooling device providing a cooling function to cool the sandwich structure into a compacted solid.

8. The system according to claim 7, wherein the funnel has an opening for controlling surface patterns showered over the braid and the underlying layer, wherein the surface patterns comprise: regular strip-like patterns, dotted patterns, texture-like patterns or single-film patterns.

9. The system according to claim 7, wherein the foaming furnace has upper and lower heating devices, and a temperature of the foaming furnace can reach 200° C.

10. The system according to claim 7, further comprising a retractor for retracting a semi-facture formed after cooling.
